(19) United States
(12) Patent Application Publication
(10) Pub. No.: US 2016/0027575 A1
(43) Pub. Date: Jan. 28, 2016

(54) CIRCUIT BOARD MAGNETIC COMPONENT WITH INTEGRATED GROUND STRUCTURE AND METHODS FOR MANUFACTURE

(71) Applicant: COOPER TECHNOLOGIES COMPANY, Houston, TX (US)

(72) Inventors: Yipeng Yan, Shanghai (CN); Robert Bogert, Lake Worth, FL (US); Zhenhua Zhang, Jiangsu (CN); Zengzhuo Deng, Guangdong (CN)

(21) Appl. No.: 14/875,847

(22) Filed: Oct. 6, 2015

Related U.S. Application Data
(63) Continuation of application No. PCT/US2014/032445, filed on Apr. 1, 2014.

(30) Foreign Application Priority Data
Apr. 7, 2013 (CN) 201310225848.X

(51) Int. Cl. H01F 27/36; H01F 41/32

(52) U.S. Cl. CPC H01F 27/362; H01F 41/32

(57) ABSTRACT

Circuit board transformer components include a bobbin having at least one ground pin with a board pin portion and a component ground section extending substantially perpendicular to the board pin portion. The component ground section is secured to a magnetic piece or the bobbin to address electromagnetic interference in a power supply application. The components are manufacturable with a reduced number of steps and greater uniformity with improved performance characteristics.

### CROSS REFERENCE TO RELATED APPLICATIONS

This application is a continuation application of International Application No. PCT/US2014/032445, which claims priority to Chinese Patent Application No. 201310225848.X filed Apr. 7, 2013.

### BACKGROUND OF THE INVENTION

The field of the invention relates generally to the manufacture of magnetic components, and more specifically to the manufacture of transformer devices having integrated grounding structure for circuit board applications.

Magnetic components such as inductors and transformers are now in widespread use in power supply applications for electronic devices. Transformer devices for circuit board applications are known and include primary and secondary transformer coils wound on an insulative bobbin including conductive pins to establish electrical connections in corresponding through-holes of a circuit board. The bobbin and associated coils are coupled to a magnetic core assembly, and according to well-known principles, the coils of the transformer can be used to increase or decrease a voltage input to provide a power supply output at a different voltage than the input voltage. Thus, for example, a higher voltage input can be stepped down to a lower voltage input suitable for use by the electronics on the circuit board, or a lower voltage output from the electronics on the circuit board can be stepped to a higher voltage that is input to another electrical device.

Electromagnetic interference (EMI) issues are problematic in certain applications of such transformers and corresponding improvements are desired. It is known in the art to connect a wire to the magnetic core on one end and to connect the wire to an electrically quiet node at is opposite end. One end of wire is typically connected to a conductive pin provided on the bobbin that is connected through the circuit board assembly to the quiet electrical node when the transformer is installed on the circuit board, and the other end of this wire is electrically connected to the magnetic core using conductive epoxy. Such a wire assembly process to address EMI issues is, however, complicated and time consuming. It is also subject to reliability issues and performance issues presented by varying grounding resistance as the components are used. In particular, lower grounding resistance is preferred but the actual grounding resistance is difficult to control from a manufacturing perspective. As a result, the core to pin resistance must be tested, leading to an increased cost of providing the transformer components.

U.S. Pat. No. 8,198,969 teaches a transformer component having a ground pin provided in a pocket of a bobbin, and exposing an end of the ground pin to a surface of the magnetic core. The magnetic core may be formed with a groove to receive the pin, and the pin and the core may be electrically connected with a conductive adhesive. While this construction represents considerable improvements over the wire assembly process described above, it is not completely satisfactory from a manufacturing perspective and improvements are desired.

### BRIEF DESCRIPTION OF THE DRAWINGS

Non-limiting and non-exhaustive embodiments are described with reference to the following Figures, wherein like reference numerals refer to like parts throughout the various drawings unless otherwise specified.

FIG. 1 is a front perspective view of a first exemplary core piece for an exemplary circuit board transformer component according to a first exemplary embodiment of the present invention.

FIG. 2 is a top view of the exemplary core piece shown in FIG. 1.

FIG. 3 is a bottom perspective view of an exemplary bobbin including a ground pin for use with the core piece shown in FIGS. 1 and 2.

FIG. 4 is a side view of the exemplary bobbin and ground pin shown in FIG. 3.

FIG. 5 is a perspective view of the bobbin being assembled with a magnetic core assembly including the core piece shown in FIGS. 1 and 2.

FIG. 6 is a bottom view of the assembly shown in FIG. 5 and illustrating a connection of the ground pin to the core.

FIG. 7 is similar to FIG. 6 but illustrates another stage of manufacture wherein the ground pin is adhered in place using a conductive epoxy.

FIG. 8 is a rear perspective view of the assembly shown in FIGS. 7 and 8 at another stage of manufacture wherein the transformer component is cured.

FIG. 9 is a top plan view of an exemplary bobbin including a ground pin according to a second exemplary embodiment of the present invention.

FIG. 10 is a front perspective view of the bobbin shown in FIG. 9.

FIG. 11 is a front perspective view of a magnetic core piece for use with the bobbin shown in FIGS. 9 and 10.

FIG. 12 is a top plan view of the magnetic core piece shown in FIG. 9.

FIG. 13 is a perspective view of the bobbin shown in FIGS. 8 and 9 being assembled the magnetic core piece shown in FIGS. 11 and 12 and illustrating a connection of the ground pin to the core.

FIG. 14 is a view similar to FIG. 13 but showing a second magnetic core piece in the assembly.

FIG. 15 is view similar to FIG. 14 but illustrating another stage of manufacture wherein the ground pin is adhered in place using a conductive epoxy.

FIG. 16 is a view similar to FIG. 15 but illustrating the component at another stage of manufacture wherein the transformer component is cured.

FIG. 17 is a front perspective view of a magnetic core piece according to a third exemplary embodiment of the present invention.

FIG. 18 is a top plan view of the magnetic core piece shown in FIG. 17.

FIG. 19 is a front perspective view of an exemplary bobbin including a ground pin for use with the magnetic core piece shown in FIGS. 17 and 18.

FIG. 20 is a side elevational view of the exemplary bobbin shown in FIG. 19.

FIG. 21 is a perspective view of the bobbin shown in FIGS. 19 and 20 being assembled with a magnetic core assembly including the core piece shown in FIGS. 17 and 18 and illustrating a connection of the ground pin to the magnetic core piece.

FIG. 22 is a view similar to FIG. 21 but illustrating another stage of manufacture wherein the ground pin is adhered in place using a conductive epoxy.

FIG. 23 is a side view of the assembly shown in FIG. 21 illustrating a connection of the ground pin to the magnetic core piece.

FIG. 24 is a side view of the assembly shown in FIG. 22 component at another stage of manufacture wherein the wherein the ground pin is adhered in place using a conductive epoxy.

FIG. 25 is a front perspective view of a magnetic core piece according to a fourth exemplary embodiment of the present invention.

FIG. 26 is a top plan view of the magnetic core piece shown in FIG. 25.

FIG. 27 is a rear perspective view of an exemplary bobbin including a ground pin for use with the magnetic core piece shown in FIGS. 25 and 26.

FIG. 28 is a bottom view of the exemplary bobbin shown in FIG. 27.

FIG. 29 is rear perspective view of the bobbin shown in FIG. 27 and illustrating a connection of the ground pin to the bobbin

FIG. 30 illustrates the bobbin shown in FIG. 29 being assembled with the magnetic core piece shown in FIGS. 25 and 26.

FIG. 31 illustrates the assembly of FIG. 31 provided with a second magnetic core piece.

FIG. 32 is a comparative ground resistance chart of conventional transformer components and components fabricated in accordance with embodiments of the present invention.

### DETAILED DESCRIPTION OF THE INVENTION

Exemplary embodiments of circuit board transformer components are described herein that simplify the grounding structure to address EMI concerns, enhance reliability of the manufactured components, and achieve better grounding performance (i.e., lower the grounding resistance of manufactured components relative to known components of the type described above). Method aspects will be in part apparent and in part explicitly discussed in the following description.

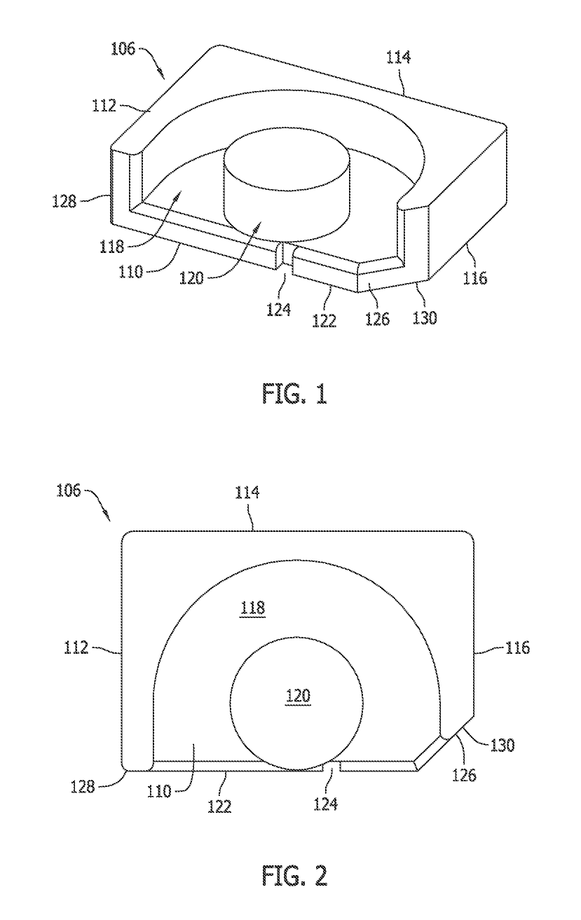

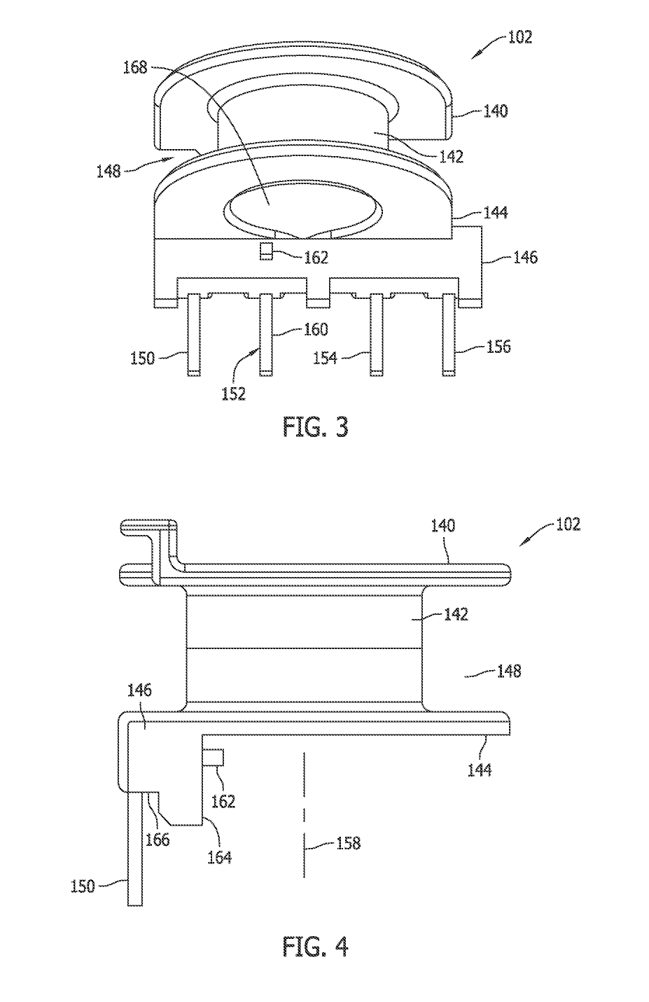

FIGS. 1-8 collectively illustrate a first exemplary embodiment of a circuit board transformer component 200 (FIGS. 4-6) generally including a bobbin 102 that is separately illustrated in FIGS. 3 and 4) and a magnetic body 104 fabricated from a first magnetic piece 106 that is separately illustrated in FIGS. 1 and 2, and a second magnetic piece 108.

Referring now to FIGS. 1 and 2, the first magnetic piece 106 generally includes a generally flat or planar base 110 and upstanding side walls 112, 114, and 116 extending upwardly from the base. The sidewalls 112, 114, 116 are generally straight and rectilinear on their exterior but are round on the interior to define a substantially semicircular interior recess or receptacle 118 above the base 110. A round projection 120 extends upwardly from the base 110 in a central portion of the receptacle 118. In the example shown, the periphery of the projection 120 is generally circular and completes a 360° arc on the base 110, while the receptacle 118 is open sided and completes much less than a 360° arc above the base 110.

A front edge 122 of the base 110 is exposed and in the example shown includes a groove 124 and a tapered side edge 126. The tapered side edge 126 imparts a triangular-shaped or wedge-shaped front corner adjacent the front edge 122. The opposite corner of the front edge 122 as shown does not include a tapered corner such as the side edge 126. The side walls 112 and 114 further include exposed front surfaces 128, 130 extending above the front edge 122 of the base 110. The front edge 122 of the base 110 may also be chamfered as shown to assist with seating of the bobbin 102 in a desired position and orientation.

The core piece 106 may be fabricated from a known magnetic material according to known processes. The core piece 108 (FIGS. 4-8) may be fabricated as essentially an identical piece to the core piece 106 in contemplated embodiments. It is noted, however, that the groove 124 may be considered optional in the core piece 108 and need not be included.

Referring now to FIGS. 3 and 4, the bobbin 102 is fabricated from an electrically nonconductive or insulative material and generally includes an upper flange 140, a tubular body 142, a lower flange 144 and a connecting portion 146. The flanges 140, 144 define a winding space 148 to accommodate a primary winding or coil and a secondary winding or coil according to known methods and techniques. The coils or windings are terminated or connected to one of a plurality of electrically conductive pins 150, 152, 154, 156 provided in the connecting portion 146. The pins 150, 152, 154, 156 generally extend downwardly from the connecting portion 146 and generally parallel to a longitudinal axis 158 of the tubular portion 142.

One of the pins, namely the pin 152 in the example of FIGS. 3 and 4, is a ground pin and includes an axial pin board portion 160 extending generally parallel to the axis 158 and the other pins 150, 154, 156 for connection to a circuit board via a through-hole therein, and a component ground portion 162 extending generally perpendicular to the axis 158 and the other pins 150, 154, 156. In other words, and unlike the other pins 150, 154, 156, the ground pin 152 includes a right angle bend with the ground portion 162 extending from one side of the right angle bend and the pin board portion 160 extending from the other side of the right angle bend. As such, the ground portion 162 extends perpendicularly from a vertical side wall 164 of the connecting portion 146 as best shown in FIG. 4, while the pin board portion 160 extends perpendicularly from a bottom wall 166 of the connecting portion 146. The right angle bend facilitates the connection of the ground pin 152 to the core piece 106 as further explained below. The other pins 150, 154, 156 are substantially straight and do not include a right angle bend.

The flanges 140, 144 each include a central opening 168 communicating with a hollow interior of the tubular portion 142. The central opening 168 cooperates with the projections 120 of the magnetic core piece 106 (FIGS. 1 and 2) when the bobbin 102 is assembled to the core piece 106.

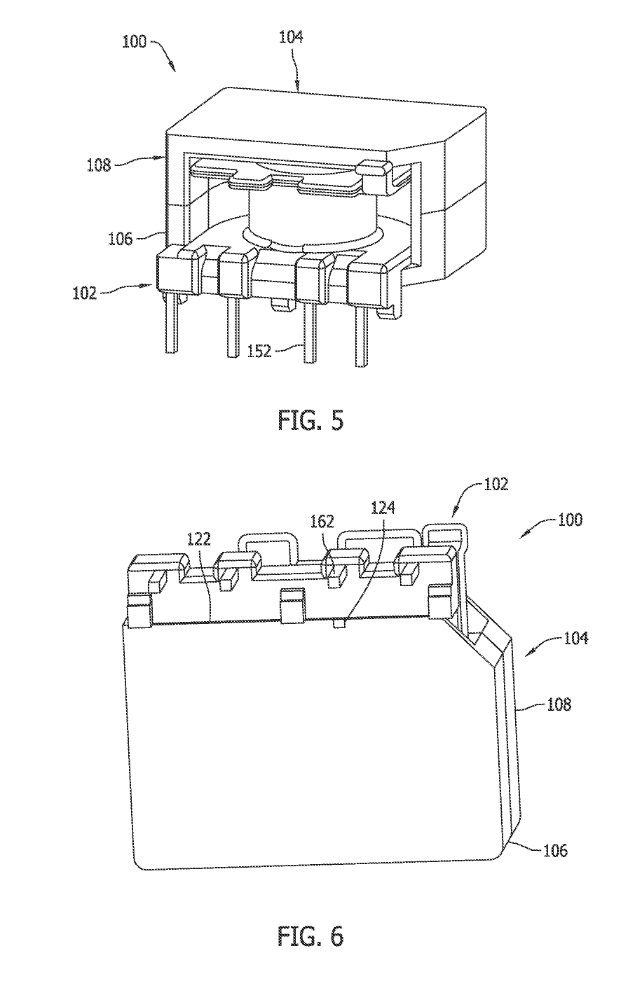

As shown in FIG. 5, the bobbin 102 may be sandwiched between the core pieces 106 and 108, using the openings 168 (FIG. 3) in the bobbin 102 and the projections 120 (FIGS. 1 and 2) in the core pieces 106 and 108 to guide the pieces into the proper orientation. The magnetic core pieces 106 and 108 may be gapped from one another when assembled to the bobbin 102 in any manner known in the art.

As best shown in FIG. 6, as the bobbin 102 is assembled to the core piece 106, the component ground portion 162 of the ground pin 152 becomes received in the groove 124 at the core piece front edge 122.

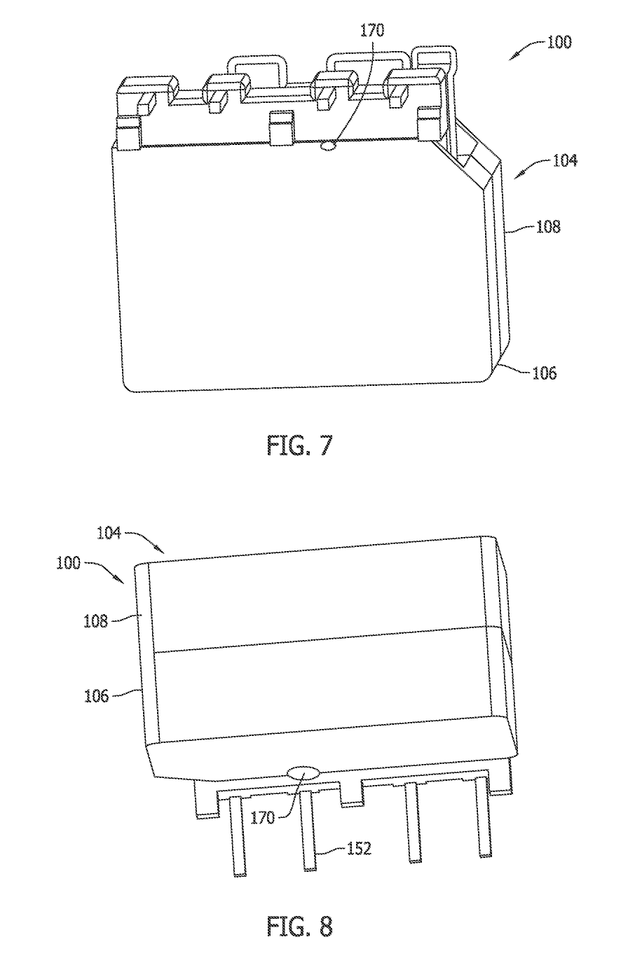

FIG. 7 shows a conductive epoxy 170 being applied to the groove 124 as the component ground portion 162 is mated with the groove. As shown in FIG. 8, the component ground portion 162 is secured in the groove 124 with the conductive epoxy and the entire component 100 is baked to cure.

The connection of the component ground portion 162 and the core piece 106 via the groove 124 may be reliably accomplished in fewer manufacturing steps and at comparatively lower cost than has conventionally been provided.

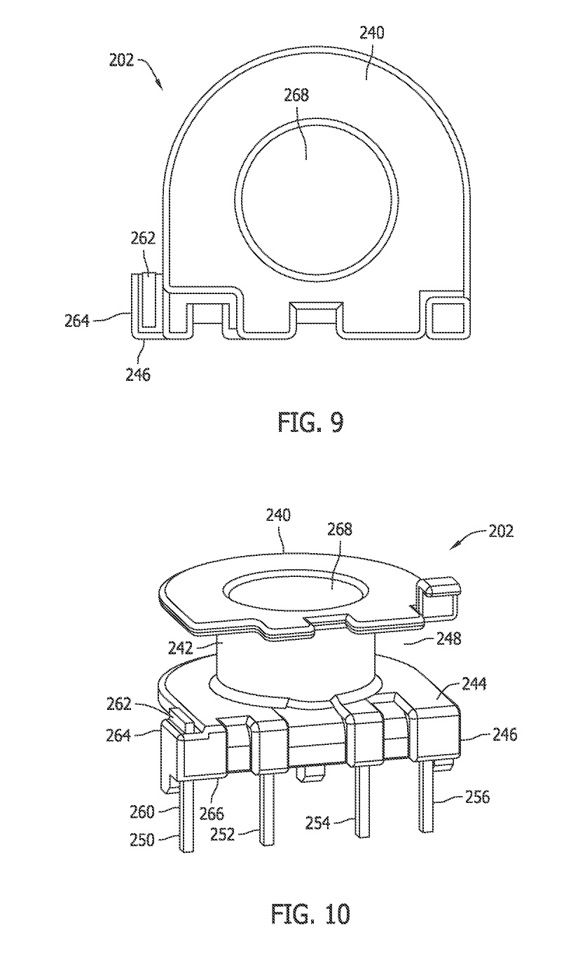

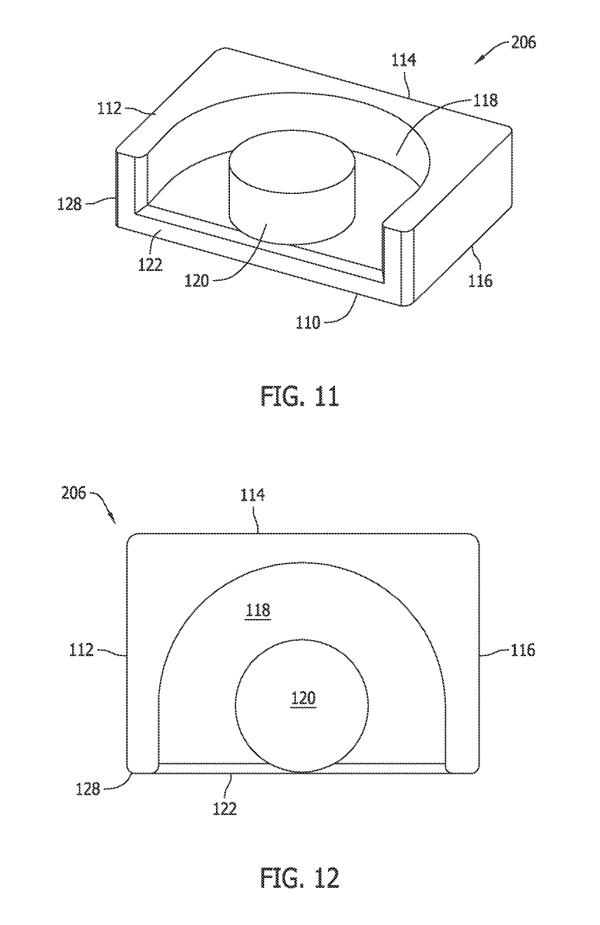

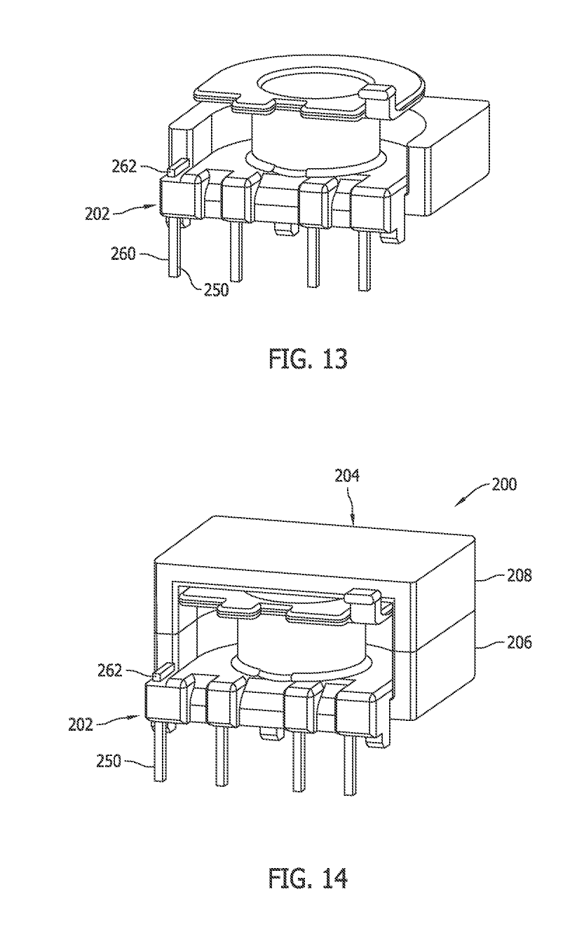

FIGS. 9-16 collectively illustrate a second exemplary embodiment of a circuit board transformer component 200 (FIGS. 13-16) generally including a bobbin 202 that is separately illustrated in FIGS. 9 and 10) and a magnetic body 204 fabricated from a first magnetic piece 206 that is separately illustrated in FIGS. 11 and 12, and a second magnetic piece 208.

Referring now to FIGS. 11 and 12, the first magnetic piece 206 generally includes a generally flat or planar base 110 and upstanding side walls 112, 114, and 116 extending upwardly from the base 110. The sidewalls 112, 114, 116 are generally straight and rectilinear on their exterior but are round on the interior to define a substantially semicircular interior recess or receptacle 118 above the base 110. A round projection 120 extends upwardly from the base 110 in a central portion of the receptacle 118. In the example shown, the periphery of the projection 120 is generally circular and completes a 360° arc on the base 110, while the receptacle 118 is open sided and completes much less than a 360° arc above the base 110.

A front edge 122 of the base 110 is exposed and unlike the core piece 106 (FIGS. 1 and 2) in the example core piece 206 as shown the groove 124 and the tapered side edge 126 are omitted. The front edge 122 of the base 110 in the core piece 106 is entirely straight and linear, and in the example shown may also be chamfered as shown to assist with seating of the bobbin 202 in a desired position and orientation.

The core piece 206, like the core piece 106 may be fabricated from a known magnetic material according to known processes. The core piece 208 (FIGS. 14-16) may be fabricated as essentially an identical piece to the core piece 206 in contemplated embodiments.

Referring now to FIGS. 9 and 10, the bobbin 202 is fabricated from an electrically nonconductive or insulative material and generally includes an upper flange 240, a tubular body 242, a lower flange 244 and a connecting portion 246. The flanges 240, 244 define a winding space 248 to accommodate a primary winding or coil and a secondary winding or coil according to known methods and techniques. The coils or windings are terminated or connected to one of a plurality of electrically conductive pins 250, 252, 254, 256 provided in the connecting portion 246. The pins 250, 252, 254, 256 generally extend downwardly from the connecting portion 246 and generally parallel to a longitudinal axis (not shown in FIG. 10 but similar to the axis 158 shown in FIG. 4).

One of the pins, namely the pin 250 in the example of FIGS. 9 and 10, is a ground pin and includes an axial pin board portion 260 extending generally parallel to the axis of the other pins 252, 254, 256 for connection to a circuit board via a through-hole therein, and a component ground portion 262 extending generally perpendicular to the axis of the other pins 252, 254, 256. In other words, and unlike the other pins 252, 254, 256, the ground pin 250 includes a right angle bend with the ground portion 262 extending from one side of the right angle bend and the pin board portion 260 extending from the other side of the right angle bend. As such, the ground portion 262 in the example shown in FIGS. 9 and 10 extends parallel to a horizontal upper wall 264 of the connecting portion 246, while the pin board portion 260 extends perpendicularly from a bottom wall 266 of the connecting portion 246. The right angle bend facilitates the connection of the ground pin 250 to the core piece 206 as further explained below.

The flanges 240, 244 each include a central opening 268 communicating with a hollow interior of the tubular portion 242. The central opening 268 cooperates with the projections 120 of the magnetic core piece 206 (FIGS. 11 and 12) when the bobbin 102 is assembled to the core piece 106.

As shown in FIG. 13, the bobbin 202 may be assembled with the core piece 206, and as shown in FIG. 14, the second core piece 208 is also assembled so that the bobbin 202 is sandwiched between the core pieces 206 and 208, using the openings 268 (FIG. 10) in the bobbin 202 and the projections 120 (FIGS. 11 and 12) in the core pieces 206 and 208 to guide the pieces into the proper orientation. The magnetic core pieces 206 and 208 may be gapped from one another when assembled to the bobbin 202 in any manner known in the art.

As shown in FIGS. 13 and 14, as the bobbin 202 is assembled to the core piece 206, the component ground portion 262 is exposed on the upper wall 264 of the bobbin connecting portion 246, and the component ground portion 262 of the ground pin 250 extends to the vertical face 128 of the sidewall 112 of the magnetic core piece 206.

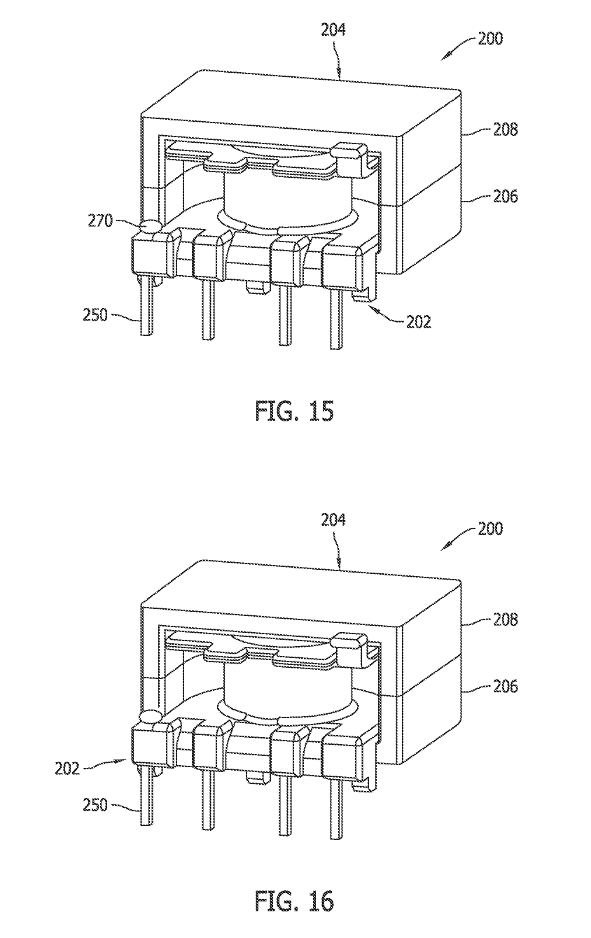

FIG. 15 shows a conductive epoxy 270 being applied to the secure the component ground portion 262 in place and ensure electrical connection to the core piece 102. As shown in FIG. 16, the entire component 200 is then baked to cure the construction.

In comparison to the first exemplary embodiment, the connection of the component ground portion 262 and the core piece 206 may be reliably accomplished in fewer manufacturing steps and at comparatively lower cost than has conventionally been provided, while providing a slightly simpler shape to the magnetic core piece 206 and also while using a different one of the pins provided on the bobbin 202 as the ground pin.

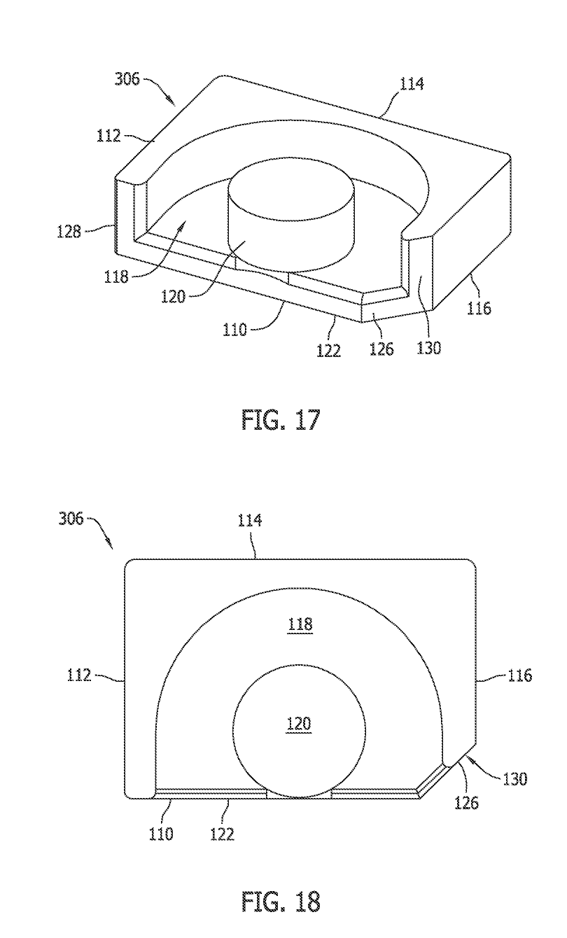

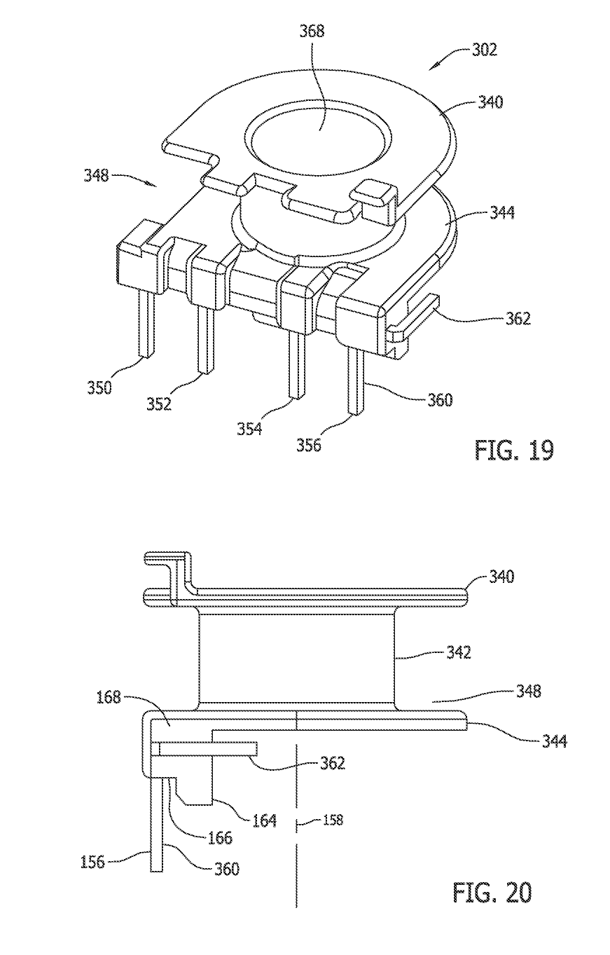

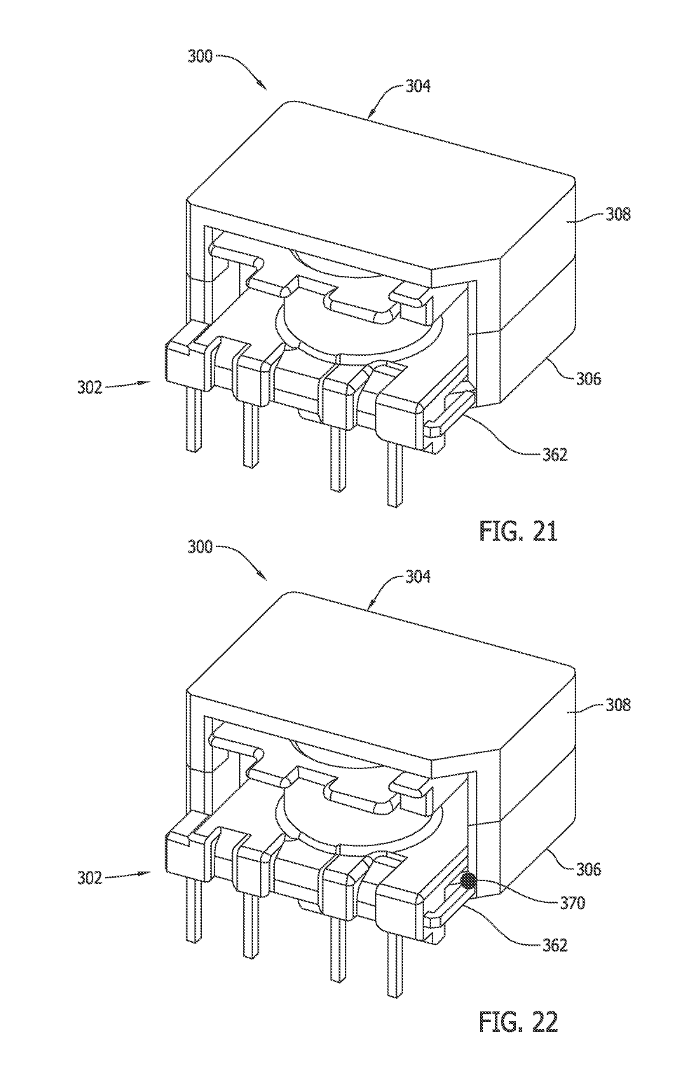

FIGS. 17-24 collectively illustrate a third exemplary embodiment of a circuit board transformer component 300 (FIGS. 21-24) generally including a bobbin 302 that is separately illustrated in FIGS. 19 and 20 and a magnetic body 304 fabricated from a first magnetic piece 306 that is separately illustrated in FIGS. 17 and 18, and a second magnetic piece 308.

Referring now to FIGS. 17 and 18, the first magnetic piece 306 generally includes a generally flat or planar base 110 and upstanding side walls 112, 114, and 116 extending upwardly from the base. The sidewalls 112, 114, 116 are generally straight and rectilinear on their exterior but are round on the interior to define a substantially semicircular interior recess or receptacle 118 above the base 110. A round projection 120 extends upwardly from the base 110 in a central portion of the receptacle 118. In the example shown, the periphery of the projection 120 is generally circular and completes a 360° arc on the base 110, while the receptacle 118 is open sided and completes much less than a 360° arc above the base 110.

A front edge 122 of the base 110 is exposed and in the example shown includes a tapered side edge 126 similar to the core piece 106 (FIGS. 1 and 2) but not a groove 124 as in the core piece 106. The tapered side edge 126 imparts a triangular-shaped or wedge-shaped front corner adjacent the front edge 122. The opposite corner of the front edge 122 as shown does not include a tapered corner such as the side edge 126. The side walls 112 and 114 further include exposed front surfaces 128, 130 extending above the front edge 122 of the base 110. The front edge 122 of the base 110 may also be chamfered as shown to assist with seating of the bobbin 302 in a desired position and orientation.

The core piece 306 may be fabricated from a known magnetic material according to known processes. The core piece 308 (FIGS. 21-24) may be fabricated as essentially an identical piece to the core piece 306 in contemplated embodiments.

Referring now to FIGS. 19 and 20, the bobbin 302 is fabricated from an electrically nonconductive or insulative material and generally includes an upper flange 340, a tubular body 342, a lower flange 344 and a connecting portion 346. The flanges 340, 344 define a winding space 348 to accommodate a primary winding or coil and a secondary winding or coil according to known methods and techniques. The coils or windings are terminated or connected to one of a plurality of electrically conductive pins 350, 352, 354, 356 provided in the connecting portion 346. The pins 350, 352, 354, 356 generally extend downwardly from the connecting portion 346 and generally parallel to a longitudinal axis 358 of the tubular portion 342.

Unlike the others, one of the pins, namely the pin 356 in the example of FIGS. 19 and 20, is a ground pin and includes an axial pin board portion 360 extending generally parallel to the axis 358 and the other pins 350, 354, 356 for connection to a circuit board via a through-hole therein, and a component ground portion 362 extending generally perpendicular to the axis 358 and the other pins 350, 352, 354. In other words, the ground pin 356 includes a right angle bend with the ground portion 362 extending from one side of the right angle bend and the pin board portion 360 extending from the other side of the right angle bend. As such, the ground portion 362 extends perpendicularly from a vertical side wall 164 of the connecting portion 146 as best shown in FIG. 20, while the pin board portion 360 extends perpendicularly from a bottom wall 166 of the connecting portion 146. The right angle bend facilitates the connection of the ground pin 152 to the core piece 106 as further explained below. Unlike the previous embodiments the ground portion 362 in the component 300 extends exterior and generally alongside a side wall 168 of the bobbin connector portion 146.

The bobbin flanges 340, 344 each include a central opening 368 communicating with a hollow interior of the tubular portion 342. The central opening 368 cooperates with the projections 120 of the magnetic core piece 306 (FIGS. 17 and 18) when the bobbin 302 is assembled to the core piece 306.

As shown in FIG. 21, the bobbin 302 may be sandwiched between the core pieces 306 and 308, using the openings 368 (FIG. 19) in the bobbin 302 and the projections 120 (FIGS. 17 and 18) in the core pieces 306 and 308 to guide the pieces into the proper orientation. The magnetic core pieces 306 and 308 may be gapped from one another when assembled to the bobbin 302 in any manner known in the art.

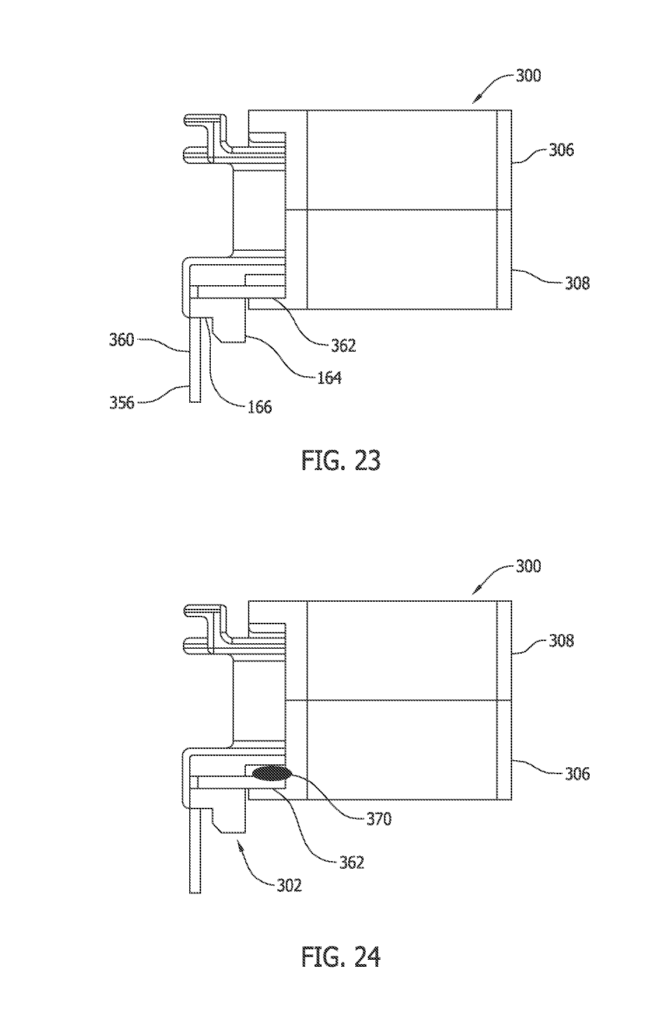

As best shown in FIGS. 21 and 23, as the bobbin 302 is assembled to the core piece 306, the component ground portion 362 of the ground pin 356 extends toward the side wall 130 of the core piece 306.

FIGS. 23 and 24 show a conductive epoxy 370 being applied to secure the component ground portion 362 of the ground pin 356 and complete the electrical connection to the core piece 306. The entire component 300 is baked to cure to cure the construction.

In comparison to the first exemplary embodiment, the connection of the component ground portion 362 and the core piece 306 may be reliably accomplished in fewer manufacturing steps and at comparatively lower cost than has conventionally been provided, while providing a slightly simpler shape to the magnetic core piece 306 and also while using a different one of the pins provided on the bobbin 302 as the ground pin.

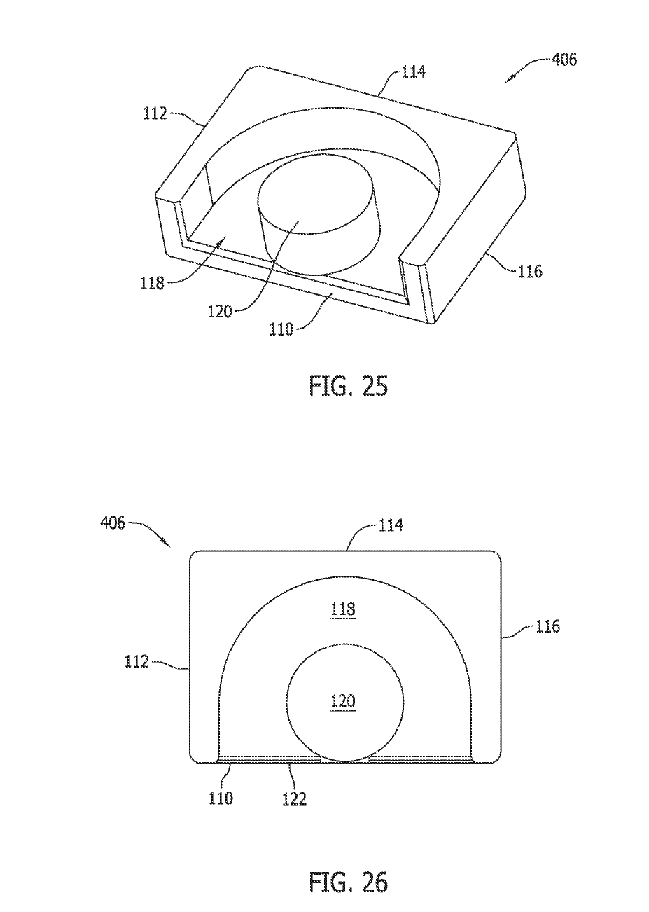

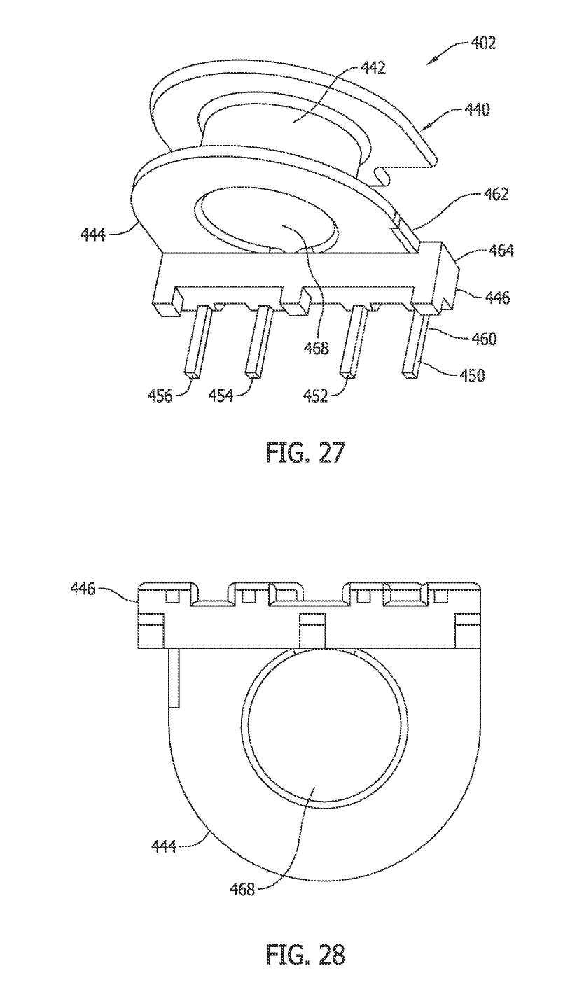

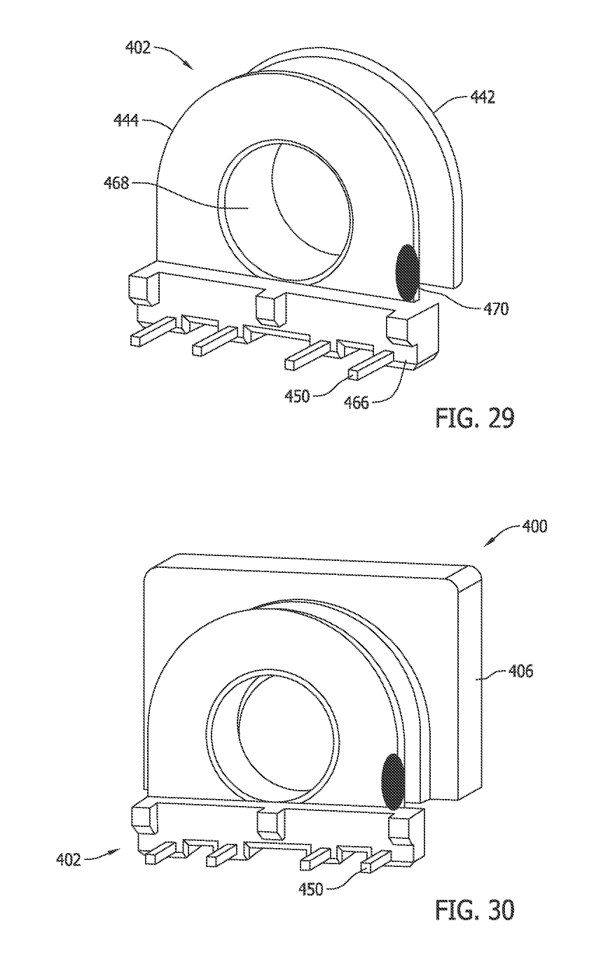

FIGS. 26-31 collectively illustrate a fourth exemplary embodiment of a circuit board transformer component 400 (FIGS. 29-31) generally including a bobbin 402 that is separately illustrated in FIGS. 27 and 28) and a magnetic body 404 fabricated from a first magnetic piece 406 that is separately illustrated in FIGS. 25 and 26, and a second magnetic piece 408.

Referring now to FIGS. 25 and 26, the first magnetic piece 406 generally includes a generally flat or planar base 110 and upstanding side walls 112, 114, and 116 extending upwardly from the base 110. The sidewalls 112, 114, 116 are generally straight and rectilinear on their exterior but are round on the interior to define a substantially semicircular interior recess or receptacle 118 above the base 110. A round projection 120 extends upwardly from the base 110 in a central portion of the receptacle 118. In the example shown, the periphery of the projection 120 is generally circular and completes a 360° arc on the base 110, while the receptacle 118 is open sided and completes much less than a 360° arc above the base 110.

A front edge 122 of the base 110 is exposed and unlike the core piece 106 (FIGS. 1 and 2) in the example core piece 206 as shown the groove 124 and the tapered side edge 126 are omitted. The front edge 122 of the base 110 in the core piece 106 is entirely straight and linear, and in the example shown may also be chamfered as shown to assist with seating of the bobbin 402 in a desired position and orientation.

The core piece 406 may be fabricated from a known magnetic material according to known processes. The core piece 408 (FIGS. 29-31) may be fabricated as essentially an identical piece to the core piece 406 in contemplated embodiments.

Referring now to FIGS. 27 and 28, the bobbin 402 is fabricated from an electrically nonconductive or insulative material and generally includes an upper flange 440, a tubular body 442, a lower flange 444 and a connecting portion 446. The flanges 440, 444 define a winding space 448 to accommodate a primary winding or coil and a secondary winding or coil according to known methods and techniques. The coils or windings are terminated or connected to one of a plurality of electrically conductive pins 450, 452, 454, 456 provided in the connecting portion 446. The pins 450, 452, 454, 456 generally extend downwardly from the connecting portion 446 and generally parallel to a longitudinal axis (not shown in FIG. 27 but similar to the axis 158 shown in FIG. 4).

One of the pins, namely the pin 450 in the example of FIG. 27, is a ground pin which, unlike the other pins includes an axial pin board portion 460 extending generally parallel to the axis of the other pins 452, 454, 456 for connection to a circuit board via a through-hole therein, and a component ground portion 462 extending generally perpendicular to the axis of the other pins 452, 454, 456. In other words, the ground pin 450 includes a right angle bend with the ground portion 462 extending from one side of the right angle bend and the pin board portion 460 extending from the other side of the right angle bend. As such, the ground portion 462 in the example shown in FIG. 27 extends parallel to a horizontal upper wall 464 of the connecting portion 446 and also parallel to a major surface of the bobbin lower flange 444, while the pin board portion 460 extends perpendicularly from a bottom wall 466 of the connecting portion 446. The right angle bend facilitates the connection of the ground pin 450 to the bobbin 402 as further explained below.

The flanges 440, 444 each include a central opening 468 communicating with a hollow interior of the tubular portion 442. The central opening 468 cooperates with the projections 120 of the magnetic core piece 406 (FIGS. 25 and 26) when the bobbin 402 is assembled to the core piece 406.

As shown in FIG. 29, the ground portion 462 of the ground pin 450 generally lies alongside the major surface of the bobbin flange 440, and may be adhered in position with conductive epoxy 470 to ensure electrical connection thereto.

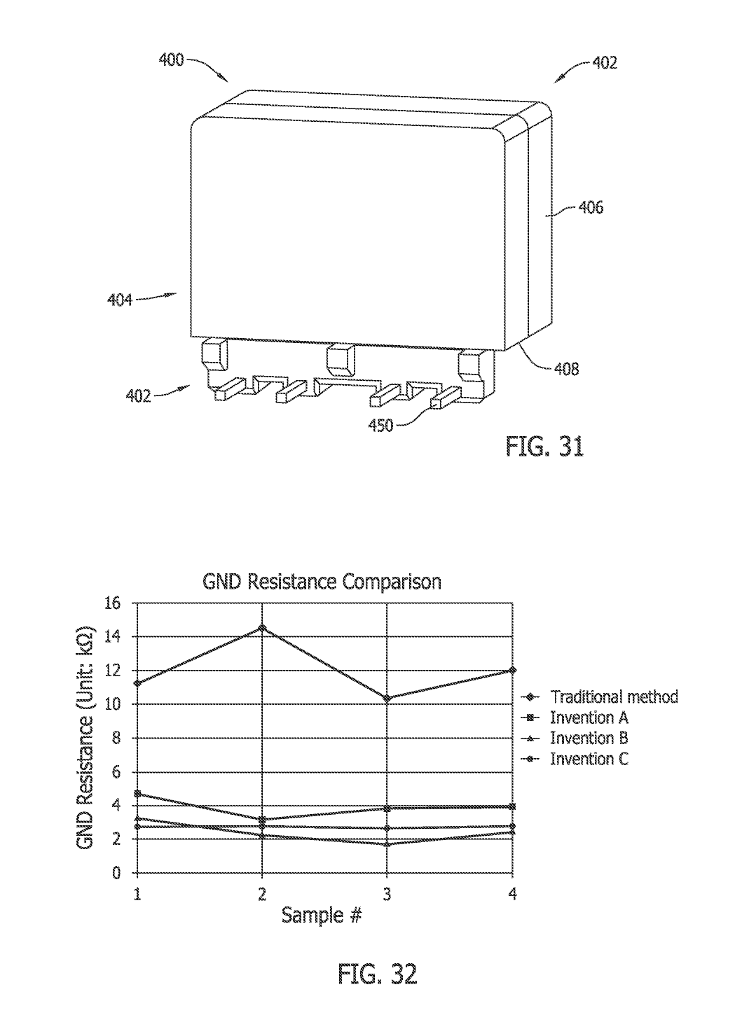

As shown in FIG. 30, the bobbin 402 may be assembled with the core piece 406, and as shown in FIG. 31, the second core piece 408 is also assembled so that the bobbin 402 is sandwiched between the core pieces 406 and 408, using the openings 468 (FIGS. 27 and 28) in the bobbin 402 and the projections 120 (FIGS. 25 and 26) in the core pieces 406 and 408 to guide the pieces into the proper orientation. The magnetic core pieces 406 and 408 may be gapped from one another when assembled to the bobbin 402 in any manner known in the art.

In comparison to the first exemplary embodiment, the connection of the component ground portion 462 and the bobbin may be reliably accomplished in fewer manufacturing steps and at comparatively lower cost than has conventionally been provided, while providing a slightly simpler shape to the magnetic core piece 406.

In comparison to conventional transformer components having a wire connected to the magnetic core on one end and connected to an electrically quiet node at is opposite end, noticeable improvements in performance have been observed. Set forth below in Table 1 is a comparative example of Direct Current Resistance (DCR) of such conventional transformer components and the embodiments described above. In Table 1, Solution A refers to the embodiment of component 100, Solution B refers to the embodiments of components 200 or 300, and Solution C refers to the embodiment of component 400 described above.

TABLE 1

DCR between core and grounding pin (kOhm)

| Sample | Traditional | Solution | Solution | Solution |
|---|---|---|---|---|
| # | method | A | B | C |
| 1 | 11.20 | 4.69 | 3.25 | 2.78 |
| 2 | 14.50 | 3.14 | 2.26 | 2.73 |
| 3 | 10.26 | 3.75 | 1.69 | 2.58 |
| 4 | 11.98 | 3.88 | 2.42 | 2.71 |

FIG. 32 is a comparative ground resistance chart of conventional transformer components and components fabricated in accordance with embodiments of the present invention. In FIG. 32, invention A refers to the embodiment of component 100, invention B refers to the embodiments of components 200 or 300, and invention C refers to the embodiment of component 400 described above.

The benefits and advantages of the inventive concepts herein are now believed to be evident in view of the exemplary embodiments disclosed.

An embodiment of a circuit board transformer component has been disclosed including: a bobbin provided with a plurality of electrically conductive pins; and at least one magnetic body assembled to the bobbin, wherein at least one of the electrically conductive pins is a ground pin comprising a board pin portion and a component ground section extending substantially perpendicular to the board pin portion.

Optionally, the bobbin may include a connecting portion having a rear wall, and the component ground section of the ground pin may extend perpendicular to the rear wall. The magnetic body may include a first magnetic core piece, the first magnetic core piece comprising a front edge and a groove formed in the front edge. The component ground section of the ground pin may be received in the groove. A conductive epoxy securing the component ground section to the first magnetic core piece.

Also optionally, the bobbin may include a connecting portion having an upper wall, and the component ground section of the ground pin may extend alongside the upper wall. The magnetic body may include a first magnetic core piece, and the first magnetic core piece may include a base and a side wall extending upwardly from the base. The component ground section may extend toward the side wall. A conductive epoxy may secure the component ground section to the side wall of the first core piece.

The bobbin may optionally include a connecting portion having a side wall, and the component ground section of the ground pin may extend alongside the side wall. The magnetic body may include a first magnetic core piece, and the first magnetic core piece may include a front edge and a tapered section along a portion thereof. The component ground section may extend toward the tapered section. A side wall may extending from the tapered section, and a conductive epoxy may secure the component ground section to the side wall of the tapered section.

Optionally, the bobbin may further include at least one flange, and the component ground section may extend parallel to the at least one flange. The component ground section may extend alongside the at least one flange. A conductive epoxy may secure the component ground section to the at least one flange.

Optionally, the magnetic body may include a first magnetic piece and a second magnetic piece sandwiching the bobbin. The bobbin may include a first flange, a second flange and a winding space therebetween, and the connecting portion may extend adjacent one of the first and second flanges. The plurality of pins may extend from the connector portion in a row. The ground pin may be located on the end of the row, or the ground pin may be located adjacent at least two other pins in the row. The bobbin may also include a first flange, a second flange and a tubular portion extending therebetween. The tubular portion may define an axis, and the board pin portion may extend parallel to the axis.

An embodiment of a circuit board transformer component is also disclosed. The transformer component includes: a bobbin defining a winding space and a connector portion provided with a plurality of electrically conductive pins; at least one magnetic body assembled to the bobbin, wherein at least one of the electrically conductive pins is a ground pin comprising a board pin portion and a component ground section extending substantially perpendicular to the board pin portion; and a conductive epoxy securing the component ground section to at least of the magnetic body and the bobbin.

A method of manufacturing a circuit board transformer component is also disclosed. The method includes: providing a bobbin defining a winding space and a connector portion provided with a plurality of electrically conductive pins, at least one of the electrically conductive pins being a ground pin having a board pin portion and a component ground section extending substantially perpendicular to the board pin portion; assembling the bobbin with at least one magnetic body; and securing the component ground section to at least of the magnetic body and the bobbin with a conductive epoxy.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A circuit board transformer component comprising:
at least one magnetic core piece defining a base, a plurality of sidewalls extending upwardly from the base and a rounded interior receptacle defined between the plurality of side walls;
a bobbin including at least one flange portion extending in the rounded interior receptacle and a connecting portion extending from the at least one flange portion, the connecting portion provided with a plurality of electrically conductive pins, and at least one of the electrically conductive pins comprising a board pin portion, a component ground section and a right angle bend extending between the board pin portion and the component ground section; and
a conductive epoxy securing the component ground section to at least one of the magnetic body and the bobbin.

2. The transformer component of claim 1, wherein the rounded interior receptacle is open sided and the at least one magnetic core piece includes a plurality of exposed edge surfaces at an end of the open sided receptacle.

3. The transformer component of claim 2, wherein one of the plurality exposed edge surfaces includes a groove, and wherein a portion of the component ground section and a portion of the conductive epoxy is received in the groove.

4. The transformer component of claim 3, wherein the groove is formed in an exposed front edge of the base.

5. The transformer component of claim 2, wherein the connecting portion includes opposing first and second sidewalls, the component ground section extending along one of the opposed first and second sidewalls of the connecting portion toward one of the plurality of exposed edge surfaces of the at least one magnetic core piece, and the conductive epoxy securing the component ground section to the one of the plurality of exposed edge surfaces.

6. The transformer component of claim 5, wherein the plurality of exposed edge surfaces includes a tapered edge, and the conductive epoxy secures the component ground section to the tapered side edge.

7. The transformer component of claim 1, wherein the rounded interior receptacle is substantially semicircular.

8. The transformer component of claim 1, wherein the at least one magnetic core piece includes a projection in the rounded interior receptacle.

9. The transformer component of claim 7, wherein the bobbin further comprises a hollow body, the hollow body cooperating with the projection to guide assembly of the at least one magnetic core piece and the bobbin.

10. The transformer component of claim 1, wherein the component ground section extends along the at least one flange of the bobbin, and wherein the conductive epoxy secures the component ground section to the at least one flange.

11. The transformer component of claim 1, wherein the bobbin comprises a first flange, a second flange and a winding space between the first flange and the second flange.

12. The transformer component of claim 11, wherein the at least one magnetic core piece comprises a first magnetic core piece and a second magnetic core piece, wherein the bobbin including the first flange, the second flange and the winding space is sandwiched between the first and second magnetic core piece.

13. The transformer component of claim 1, wherein the plurality of pins extend from the connecting portion in a row, and wherein the ground pin is located on an end of the row.

14. The transformer component of claim 1, wherein the plurality of pins extend from the connecting portion in a row, and wherein the ground pin is located adjacent at least two other pins in the row.

15. A circuit board transformer component comprising:
a magnetic body including at least one magnetic core piece having a planar base, a plurality of sidewalls extending above the base, and a substantially semicircular interior recess defined between the plurality of side walls;
a bobbin including a least one flange, a winding space defined adjacent the at least one flange, and a connecting portion provided with a plurality of electrically conductive pins;
wherein the at least one flange is inserted into the substantially semicircular interior recess, and wherein at least one of the electrically conductive pins is a ground pin comprising a board pin portion and a component ground section extending perpendicular to the board pin portion; and
a conductive epoxy securing the component ground section to at least one of the magnetic body and the bobbin.

16. The transformer component of claim 15, wherein the at least one magnetic core piece includes a groove, and a portion of the component ground section received in the groove.

17. The transformer component of claim 15, wherein the at least one magnetic core piece includes at least one edge surface, and the component ground section being secured to the at least one edge surface via the conductive epoxy.

18. The transformer component of claim 17, wherein the at least one edge surface is a tapered edge surface.

19. The transformer component of claim 15, wherein the component ground section extends along the at least one flange, and the conductive epoxy secures the component ground section to the at least one flange.

20. A method of manufacturing a circuit board transformer component, the method comprising:
providing at least one magnetic core piece including a base, a rounded interior receptacle formed above the base, and a projection extending from the base in the rounded interior receptacle;
providing a bobbin including a hollow body and a winding space extending between first and second flanges, and a connecting portion extending from one of the first and second flanges, the connecting portion provided with a plurality of electrically conductive pins, at least one of the electrically conductive pins being a ground pin having a board pin portion and a component ground section extending substantially perpendicular to the board pin portion;
assembling the bobbin to the at least one magnetic core piece using the hollow body and the projections as a guide; and
securing an end of the component ground section to at least of the magnetic core piece and the bobbin with a conductive epoxy.
